(19) United States
(12) Patent Application Publication
(10) Pub. No.: US 2013/0169498 A1
(43) Pub. Date: Jul. 4, 2013

(54) PACKAGING MATERIAL WITH T-SHAPED SLOT ANTENNA

(71) Applicant: TAIWAN LAMINATION INDUSTRIES, INC., Chung Li City (TW)

(72) Inventor: Yung-Shun CHEN, Chung Li City (TW)

(73) Assignee: TAIWAN LAMINATION INDUSTRIES, INC., Chung Li City (TW)

(21) Appl. No.: 13/667,026

(22) Filed: Nov. 2, 2012

(30) Foreign Application Priority Data
Dec. 28, 2011 (TW) 100149151

(51) Int. Cl. H01Q 13/10

(52) U.S. Cl. CPC H01Q 13/10
USPC 343/770

(57) ABSTRACT

The present invention is to provide a packaging material having a T-shaped slot antenna, which includes a surface material being a plastic film and having one surface coated with a metal layer, a bottom material being a plastic film and having one surface coated on the metal layer, and a communication device having two conductive sheets connected to either the surface or bottom material. The surface material, metal layer and bottom material are formed with a T-shaped slot for forming the T-shaped slot antenna, wherein the T-shaped slot includes a vertical groove having one end connected to central position of a horizontal groove and an opposite end extending toward a lateral edge of the metal layer. The corresponding lateral edges of the conductive sheets are spaced from each other and are connected with feed-in ends of a communication chip respectively for receiving or transmitting information via the T-shaped slot antenna.

### FIELD OF THE INVENTION

The present invention relates to a packaging material, more particularly to a packaging material having a T-shaped slot antenna, for enabling a communication chip attached thereon to receive or transmit information via the T-shaped slot antenna.

### BACKGROUND OF THE INVENTION

Radio-frequency identification (REID) is now widely used in logistics management to monitor in real time the different stages of a product, i.e., from production to transportation to distribution to sale. With RFID, those who monitor the entire process can precisely control information related to the product (e.g., product type, manufacturer's information, product specifications, quantities, places of arrival, recipients, and so on). Generally speaking, the RFID technology enables an identification system (e.g., a reader) to identify a specific object, commonly known as an RFID tag, and read/write data from/into this object by means of electromagnetic wave signals. No mechanical or optical contact is required between the identification system and the specific object.

RFID tags can be divided into three categories: passive tags, semi-passive (or semi-active) tags, and active tags, whose major properties and differences are briefly stated as follows:

1. Passive RFID tags: This type of tags do not have an internal power source. The integrated circuit in a passive RFID tag is driven by electromagnetic waves received from a reader. A passive RFID tag can transmit data to a reader only when the electromagnetic wave signal received is of sufficient strength.

2. Semi-passive RFID tags: These tags are similar to the passive ones except that a small battery is provided therein. The battery in such an RFID tag provides the exact amount of electricity required to drive the integrated circuit in the tag and keep the integrated circuit in operation, thereby shortening the response time, and increasing the efficiency of, the RFID tag.

3. Active RFID tags: Unlike its passive or semi-passive counterparts, an active RFID tag is equipped with an internal power supply for supplying the electricity needed by the integrated circuit in the tag to generate an outgoing signal. An active RFID tag typically has a relatively long read distance and a relatively large-capacity memory for storing the additional information transmitted from a reader.

Passive RFID tags, which require no internal power sources (e.g., batteries), have relatively low production costs and are both lightweight and compact. In addition, the relatively simple structure of a passive RFID tag ensures a relatively long service life. Therefore, passive RFID tags are more convenient to use than the other two types of tags and have become the mainstream products in today's RFID tag market. Generally, an RFID tag receives or transmits a radio signal via an antenna so as for the chip in the tag to execute the corresponding procedure. When attached to a non-conductive article (e.g., one made of plastic, paper, wood, etc.), an RFID tag can perform signal transmission wherever possible and exchange information with a reader within a predetermined range (distance). When an RFID tag is attached to the surface of a metal article, however, the metal article will, according to the image theory, generate an image pulse which is in antiphase with, and hence destructively interferes with, the electromagnetic wave signal transmitted by the transceiver antenna of the tag. As the electromagnetic wave signal will be destroyed and rendered undeliverable to the reader, the reader cannot read the information in the RFID tag.

Notwithstanding, in a logistics system where the products to be delivered must be protected from direct exposure to light or must be kept from moisture which may otherwise lead to rusting or mold growth, it is common practice to package the products in metal bags (e.g., aluminum foil bags) before delivery. The metal bags, as stated above, will make RFID tags useless because of image pulses and thus hinder precise management of the products to be delivered, which is highly undesirable. Besides, an RFID tag is often applied by adhering it manually to the surface of an article. This manual operation, however, incurs high labor costs. Therefore, the issue to be addressed by the present invention is to provide an improved design for RFID tags and the conventional metal bag structures, thereby solving the aforementioned problems, ensuring good transmission properties of RFID tags, and lowering production costs.

### BRIEF SUMMARY OF THE INVENTION

In view of the fact that an RFID tag is, in most cases, adhesively attached to the surface of a package bag which, if provided with a required metal layer, will make the RFID tag useless, the inventor of the present invention conducted extensive research and experiment and finally succeeded in developing a packaging material with a T-shaped slot antenna. It is hoped that the present invention can solve the foregoing problems effectively.

It is an object of the present invention to provide a packaging material having a T-shaped slot antenna, wherein the T-shaped slot antenna is directly formed on the packaging material during production of the packaging material and functions as the transceiver antenna of a communication device. Hence, when the packaging material is used to make package bags, the package bag manufacturer need not hire additional labor for attaching RFID tags to the package bags. Consequently, production costs are effectively reduced, and production efficiency increased. The packaging material includes a surface material, a metal layer, a bottom material, and a communication device. The surface material is a film made of a plastic material and has one surface coated with the metal layer. The bottom material is also a film made of a plastic material and has one surface coated on the metal layer. The surface material, the metal layer, and the bottom material are formed with a T-shaped slot that penetrates the three layers. The T-shaped slot includes a vertical groove and a horizontal groove. The vertical groove has one end connected to a central position of the horizontal groove and the opposite end extending toward a lateral edge of the metal layer. Thus, a T-shaped slot antenna is formed. The communication device includes two conductive sheets, a communication chip, and at least one connecting material. The conductive sheets are attached to the at least one connecting material and are connected to either the surface material or the bottom material by at least one of the at least one connecting material. The corresponding lateral edges of the conductive sheets are spaced from each other and are connected with the feed-in ends of the communication chip respectively. In addition, the communication chip corresponds in position to the vertical groove, and the conductive sheets do not cover the horizontal groove completely. As such, the communication device can receive or transmit information via the T-shaped slot antenna. When making the packaging material, the T-shaped slot antenna and the communication device can be rapidly formed on the packaging material in the same process, thereby endowing the packaging material with RFID capabilities. The packaging material can be further used to make various RFID-tagged package bags.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic exploded view of the packaging material of the present invention;

FIG. 2 schematically shows a package bag made of the packaging material of the present invention;

FIG. 3A is a schematic exploded view of an embodiment of the communication device of the present invention;

FIG. 3B is a schematic exploded view of another embodiment of the communication device of the present invention;

FIG. 4 is a schematic view of the communication device and the T-shaped slot of the present invention in the assembled state;

FIG. 5A is another schematic view of the communication device and the T-shaped slot of the present invention, showing the first assembly error;

FIG. 5B is yet another schematic view of the communication device and the T-shaped slot of the present invention, showing the second assembly error;

FIG. 5C is still another schematic view of the communication device and the T-shaped slot of the present invention, showing the third assembly error;

FIG. 5D is a further schematic view of the communication device and the T-shaped slot of the present invention, showing the fourth assembly error;

FIG. 5E is yet another schematic view of the communication device and the T-shaped slot of the present invention, showing the fifth assembly error;

FIG. 6A shows the XZ-cut (horizontal) scanning direction and radiation pattern of the packaging material of the present invention;

FIG. 6B shows the YZ-cut (vertical) scanning direction and radiation pattern of the packaging material of the present invention; and

FIG. 6C shows the XY-cut (horizontal) scanning direction and radiation pattern of the packaging material of the present invention.

### DETAILED DESCRIPTION OF THE INVENTION

As the metal layer of a package bag and the transceiver antenna of an RFID tag are both metallic, the inventor of the present invention takes advantage of this common property and uses the metal layer of a package bag as the transceiver antenna of an RFID tag. Thus, not only can the aforementioned image pulse problem be prevented during operation of such an RFID tag, but also the RFID tag can be formed on a packaging material while the latter is made, which significantly reduces the production costs of the RFID tag and enables the production of a variety of RFID-tagged products (e.g., package bags).

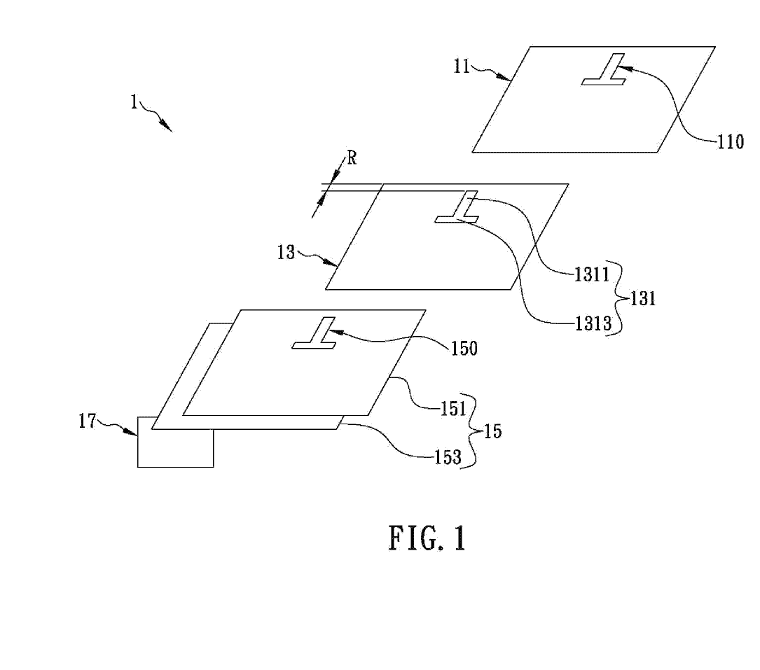

The present invention discloses a packaging material with a T-shaped slot antenna. In a preferred embodiment as shown in FIG. 1, the packaging material 1 includes a surface material 11, a metal layer 13, a bottom material 15, and a communication device 17, wherein the surface material 11 is a film made of a plastic material. In this embodiment, the plastic material of which the surface material 11 is made is polyethylene terephthalate (PET), whose dielectric constant is about 2.2˜2.3. In other embodiments of the present invention, however, other plastic materials may be used, depending on production requirements. In fact, all the materials cited herein may vary as appropriate. One surface of the surface material 11 is coated with the metal layer 13 (e.g., an aluminum foil). The metal layer 13 is depicted in FIG. 1 as a film only to facilitate disclosure of the components of the packaging material 1. In practice, the metal layer 13 may be attached to the surface material 11 by evaporation, sputtering, or the like. The bottom material 15 is a film made of a plastic material and has one surface coated on the metal layer 13. In this embodiment, the bottom material 15 is a composite material composed of two films, namely a first base layer 151 and a second base layer 153, wherein the first base layer 151 is polyamide (e.g., an oriented nylon; ONY) and the second base layer 153 is chlorinated polyethylene (CPE). In other embodiments of the present invention, though, the bottom material 15 may also be made of a single material. Hence, both the surface material 11 and the bottom material 15 may vary in composition to suit different product requirements, giving manufacturers more flexibility and a more competitive edge in terms of production.

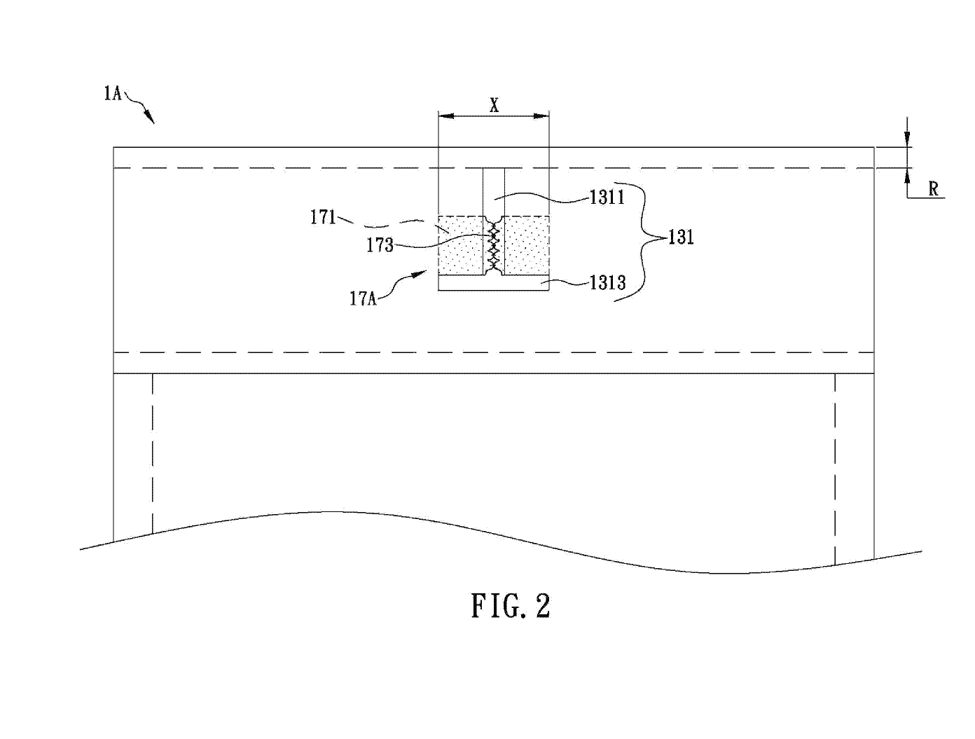

The surface material 11, the metal layer 13, and the bottom material 15 are formed with T-shaped slots 110, 131, and 150 respectively. The T-shaped slots 110, 131, and 150 have the same configuration and correspond to one another. To facilitate disclosure of the technical features of the present invention, only the T-shaped slot 131 of the metal layer 13 is described below, but it should be understood that all the T-shaped slots 110, 131, and 150 are identical in structure. As shown in FIGS. 1 and 2, the T-shaped slot 131 includes a vertical groove 1311 and a horizontal groove 1313. The vertical groove 1311 has one end connected to a central position of the horizontal groove 1313, and the other end of the vertical groove 1311 is spaced from a lateral edge of the metal layer 13 by a matching spacing R. Thus, a T-shaped slot antenna is formed. After the packaging material 1 is made into a package bag 1A, the length of the matching spacing R (i.e., the distance between the sealing edge of the package bag 1A and the unconnected end of the vertical groove 1311) can be adjusted to properly control and adjust impedance matching of the T-shaped slot antenna formed by the T-shaped slot 131. In other embodiments of the present invention, however, the matching spacing R may be dispensed with to meet product requirements, and in that case, the vertical groove 1311 is directly connected to a lateral edge of the metal layer 13. Thus, the packaging material of the present invention is applicable to a great variety of packaging products.

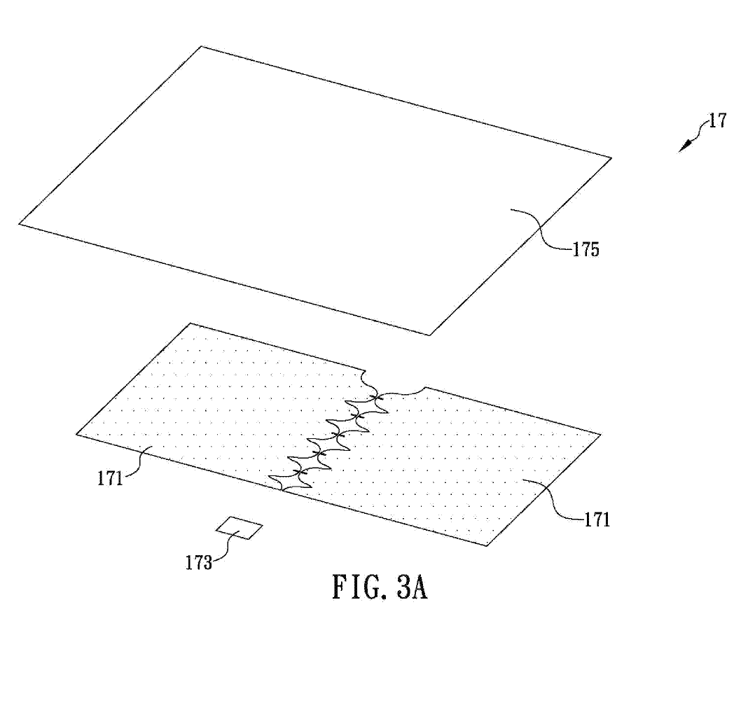

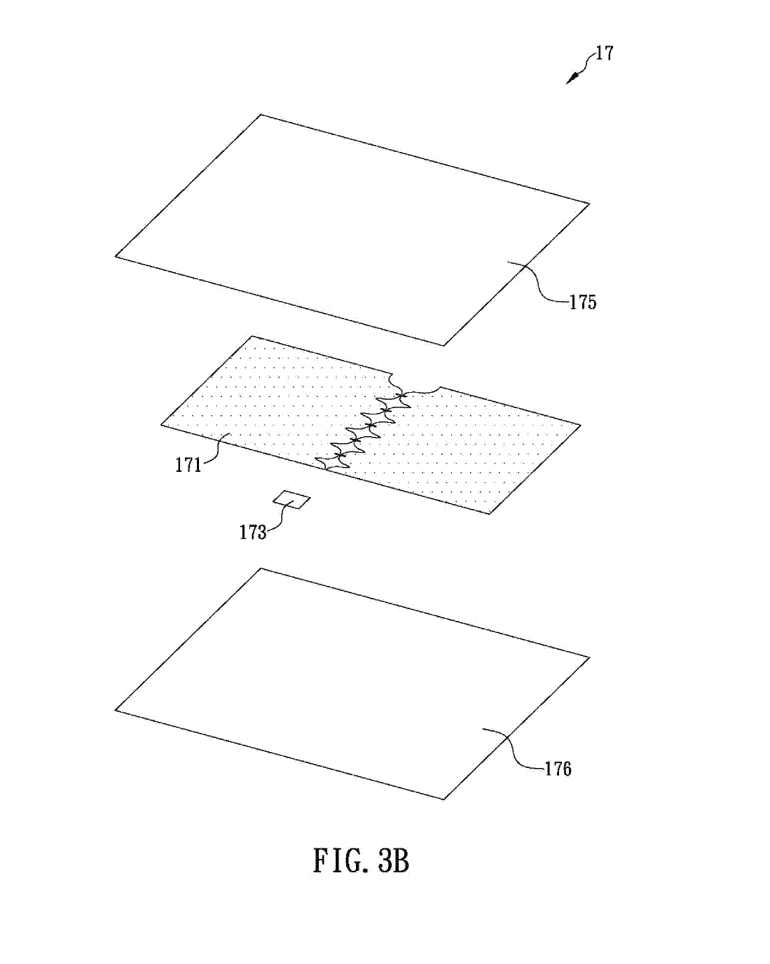

Referring to FIGS. 1 and 3A, the communication device 17 includes two conductive sheets 171, a communication chip 173, and at least one connecting material 175. The connecting material 175 is a film made of a plastic material (e.g., PET). The conductive sheets 171 may be attached to the connecting material 175 in advance. The corresponding inner lateral edges of the conductive sheets 171 are of a serrated shape and are spaced from each other, but it is also feasible to change the shape of the inner lateral edge of each conductive sheet 171. To disclose the aforesaid technical features in more detail, a method for producing the communication device 17 is described as follows, by way of example. To begin with, a metal sheet (e.g., a copper foil) is adhesively attached to the connecting material 175. The metal sheet is then shaped by etching, so as to form the conductive sheets 171 of the present invention. It is understood that the conductive sheets 171 may also be shaped by other applicable techniques. The communication chip 173 is connected to the conductive sheets 171 by a flip-chip process. More specifically, metal bumps are formed on the communication chip 173 as feed-in ends, which are subsequently and respectively connected to the corresponding inner lateral edges of the conductive sheets 171. Alternatively, the surface-mount technology (SMT) may be used to connect the feed-in ends of the communication chip 173 to the corresponding inner lateral edges of the conductive sheets 171 respectively. Since flip chip and SMT are both well known in the art, they will not be dealt with in more detail herein. Lastly, the connecting material 175 is coated with an adhesive (e.g., a low-tack adhesive), and the communication device 17 is adhesively attached to either the surface material 11 or the bottom material 15 (the bottom material 15 as in this embodiment) by the connecting material 175. In other embodiments of the present invention, however, the communication device 17 may be provided with an additional connecting material 176 as shown in FIG. 3B. This connecting material 176 is attached to the conductive sheets 171 and the communication chip 173 by an adhesive (e.g., a low-tack adhesive) such that the conductive sheets 171 and the communication chip 173 are located between the connecting materials 175 and 176. The communication device 17 can then be attached to either the surface material 11 or the bottom material 15 via the connecting material 176.

As shown in FIGS. 1 and 3A, when the communication device 17 is connected to the surface material 11 or the bottom material 15 (the bottom material 15 as in this embodiment), the communication chip 173 is at a position corresponding to the vertical groove 1311, and the peripheries of the conductive sheets 171 do not cover the horizontal groove 1313 completely (see FIG. 2). Thus, an RFID tag 17A is formed on the surface material 11 or the bottom material 15, wherein the communication chip 173 can receive and transmit information through the T-shaped slot antenna. It should be noted that the communication chip 173 corresponds in position to the vertical groove 1311 when the communication device 17 is connected to the surface material 11 or the bottom material 15. In other words, once the communication device 17 is connected to the surface material 11 or the bottom material 15, the portion of the connecting material 175 or of the connecting material 176 that corresponds to and is adjacent to the communication chip 173 (and hence the serrated portions of the conductive sheets 171) is not adhesively attached to the surface material 11 or the bottom material 15. Therefore, when the packaging material 1 of the present invention is stacked up, the portion of the connecting material 175 or 176 that corresponds to the T-shaped slots 110, 131, and 150 may easily catch dust due to the adhesive, or such portions may stick to each other, causing inconvenience of use. To prevent the aforesaid scenarios, a manufacturer may apply the adhesive to only a part of the connecting material 175 or 176, making sure that the portion of the connecting material 175 or 176 that corresponds to the T-shaped slots 110, 131, and 150 is free of adhesive.

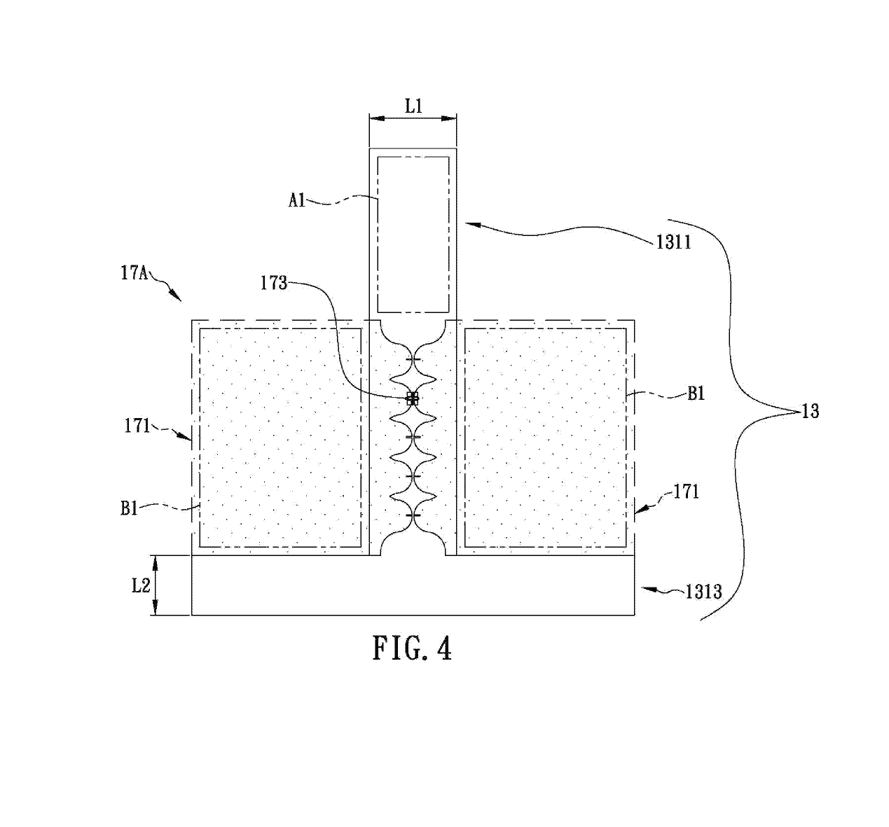

Reference is now made to FIGS. 1 and 4, in which FIG. 4 only shows the communication device 17 and the T-shaped slot 131 for the sake of clarity. The area A1 of the vertical groove 1311 that does not correspond to the conductive sheets 171 functions as a loop antenna, which features a short read distance. Meanwhile, the horizontal groove 1313 functions as a dipole antenna, which features a long read distance. Once the information related to a product is stored into the communication chip 173 by means of an electronic access device, the RFID tag 17A can be used to transmit and receive information, thereby completing the corresponding procedures of logistics management. As shown in FIG. 2, the length of the matching spacing R can be adjusted, or the matching spacing R can be omitted altogether, with a view to controlling impedance matching between the loop antenna and the dipole antenna properly. Where the matching spacing R exists, it is preferable that the length of the matching spacing R is approximately 13%˜20% of the length X between the corresponding outer lateral edges of the conductive sheets 171 that face away from each other. For example, when the length X between the corresponding outer lateral edges of the conductive sheets 171 that face away from each other is 30 mm, the matching spacing R is preferably 5 mm in length.

Referring to FIGS. 1 and 3A, the aforesaid structural design of the present invention makes it possible to rapidly form the RFID tag 17A on the packaging material 1 during the manufacturing process of the packaging material 1 rather than in a separate process. Thus, not only is the packaging material 1 provided with the capabilities of radio-frequency identification, but also the entire manufacturing process is effectively simplified, which results in a reduction in production costs. Besides, the RFID tag 17A, which is located near an edge of the packaging material 1 (see FIG. 2), is unlikely to compromise the esthetic design of the package bag 1A or like products and is less subject to damage during production and transportation than if located elsewhere. Using the packaging material 1, a manufacturer can make various RFID-tagged merchandise and, thanks to the RFID tag 17A on the merchandise, achieve real-time monitoring and management of all links in the supply chain of the merchandise, be they production, transportation, storage, distribution, sale, or even product return and after-sales services. Consequently, the efficiency of logistics management is effectively increased while management and sales costs are substantially lowered.

It should be pointed out that, referring to FIGS. 2 and 4, the RFID tag 17A of the present invention transmits electromagnetic wave energy through the coupled grooves and therefore allows a reduction in size of the antenna. The metal portion B1 of each conductive sheet 171 that is outside the T-shaped slot 131 serves mainly to increase the area of energy contact between each conductive sheet 171 and the metal layer 13 (see FIG. 1). Should this area of energy contact between the conductive sheets 171 and the metal layer 13 be too small, false signals may be generated and impair normal operation of the RFID tag 17A. In this embodiment, the packaging material 1 was tested by the inventor with the following specifications: each conductive sheet 171 is 15 mm in both length and width, the bottom material 15 is 155 μm in thickness, and the combined thickness of the connecting material 175 and the adhesive (not shown) is 100 μm Generally speaking, the length of a dipole antenna is one half of the wavelength (i.e., ½λ). At 915 MHz for example, the length of a dipole antenna should be about 16.4 cm, and yet the same antenna performance can be achieved by the present invention with the antenna length (i.e., the length of the horizontal groove 1313) being only 3 cm. It is, therefore, not necessary for a manufacturer to reserve a lot of space on the packaging material 1 for forming the RFID tag 17A, and convenience of production is thus substantially enhanced.

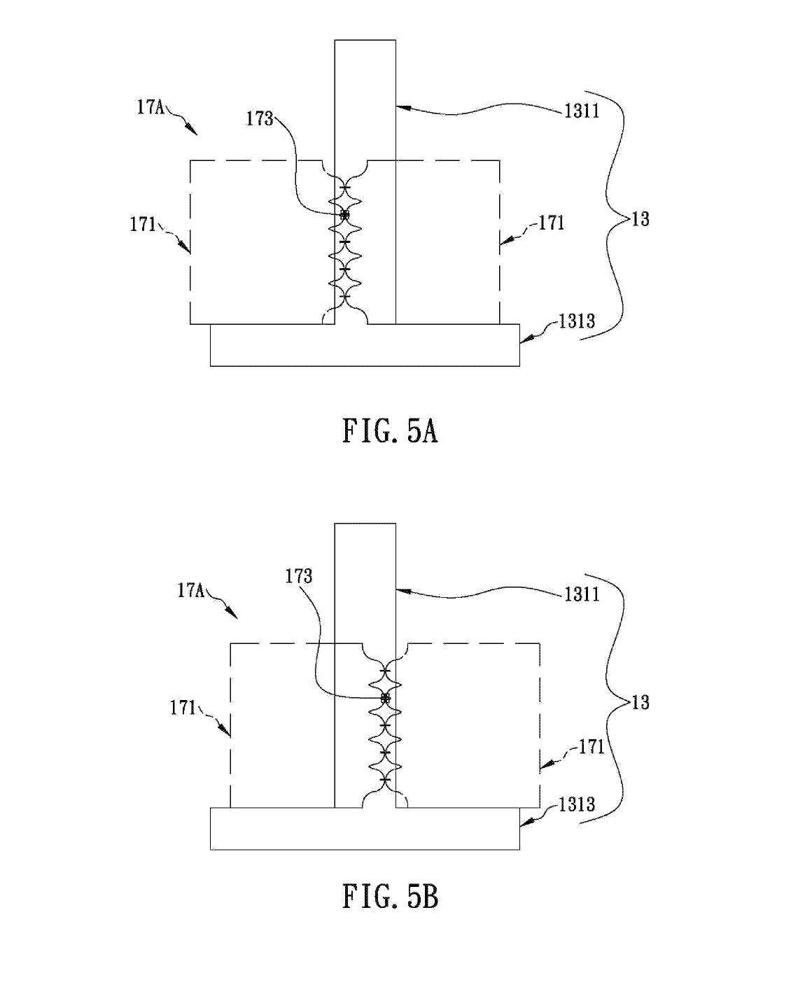

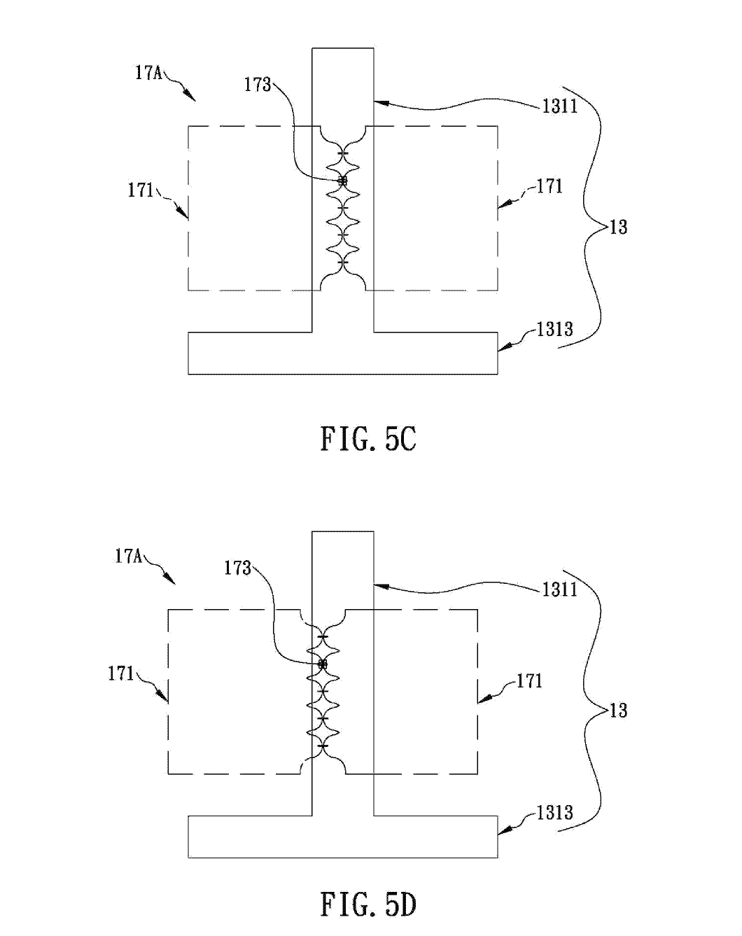

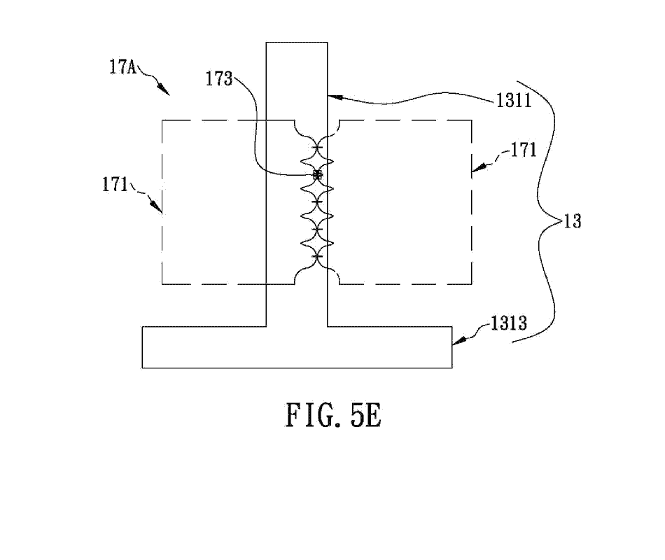

In order for the packaging material of the present invention to have good RFID capabilities, the inventor has found after numerous experiments and tests that, referring to FIGS. 2 and 4, the width L1 of the vertical groove 1311 is preferably about 16%˜24% of the length X between the corresponding outer lateral edges of the conductive sheets 171 that face away from each other, and the width L2 of the horizontal groove 1313 is preferably about 10%˜17% of the length X between the corresponding outer lateral edges of the conductive sheets 171 that face away from each other. For example, given that the package bag 1A is 340 mm long and 280 mm wide, that the RFID tag 17A corresponds in position to the central axis of the package bag 1A (i.e., with each of the two lateral edges of the horizontal groove 1313 being 125 mm away from the corresponding lateral edge of the package bag 1A), and that the length X between the t3 corresponding outer lateral edges of the conductive sheets 171 that face away from each other is 30 mm, the width L1 of the vertical groove 1311 is preferably 6 mm, and the width L1 of the horizontal groove 1313 is preferably 4 mm. If the width L1 of the vertical groove 1311 is too small, the error limits of the communication chip 173 will be adversely affected such that the operating frequency is shifted toward the high-frequency side. If the width L1 of the vertical groove 1311 is too large, however, the operating frequency will be shifted toward the low-frequency side, and the length of the horizontal groove 1313 must be increased accordingly for a match. On the other hand, if the width L2 of the horizontal groove 1313 is too small, high impedance will occur, and the horizontal groove 1313 must be lengthened for a match. If the width L2 of the horizontal groove 1313 is too large, low impedance will occur and require a reduction in length of the horizontal groove 1313 for a match, but the requirement to maintain the overall function of the RFID tag 17A leaves little room for such a reduction. In addition, when the width L1 of the vertical groove 1311 is 6 mm, the communication chip 173 preferably corresponds in position to the central axis of the vertical groove 1311, and the edges of the conductive sheets 171 are preferably flush with the edges of the horizontal groove 1313. Nonetheless, referring to FIG. 1, the communication device 17 may be shifted away from the preferred position stated above while being connected to the surface material 11 or the bottom material 15, as shown in FIGS. 5A˜5E. In spite of this, the RFID tag 17A of the present invention can work properly provided that the communication chip 173 is shifted to the left or right of the central axis of the vertical groove 1311 by not more than 2 mm or the edges of the conductive sheets 171 are shifted away from the edges of the horizontal groove 1313 by not more than 3 mm.

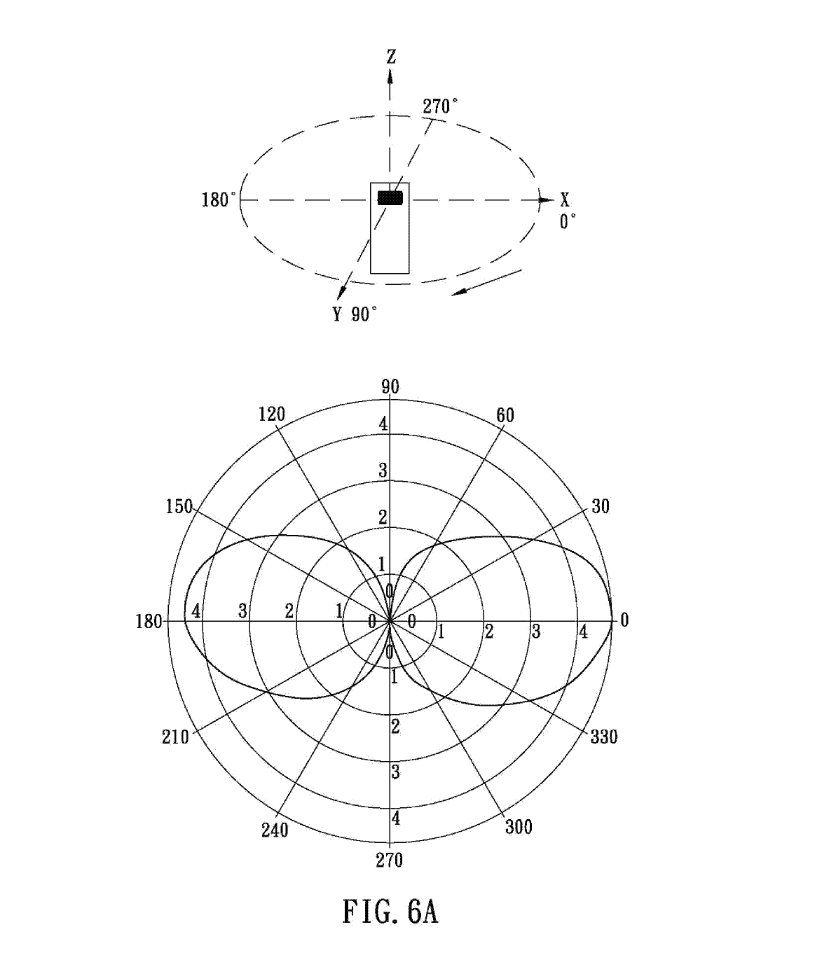

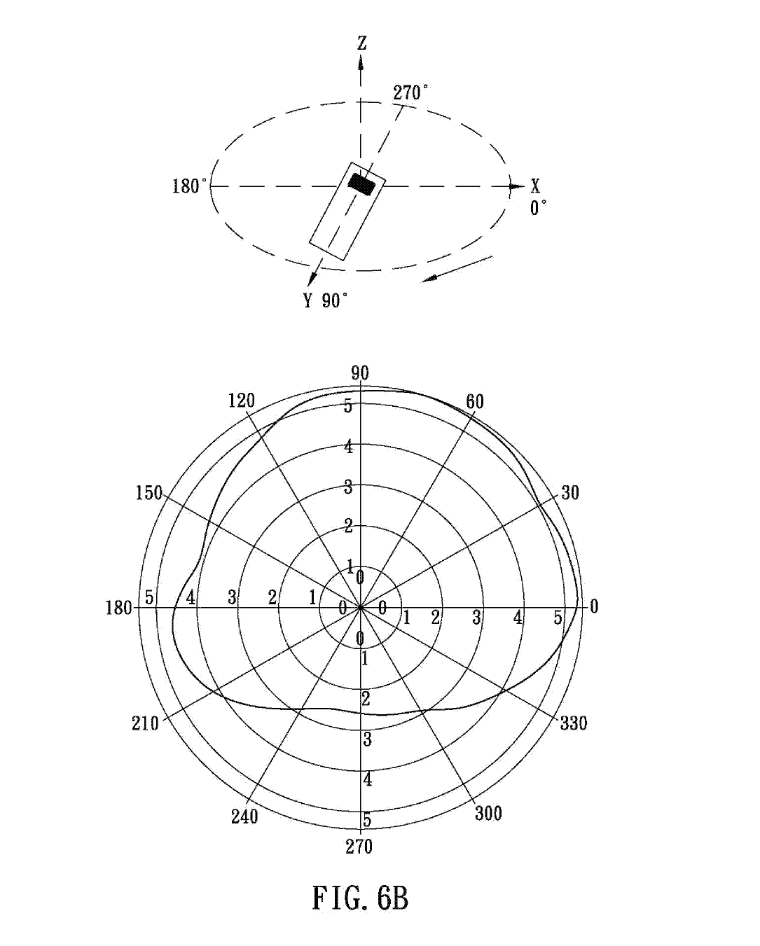

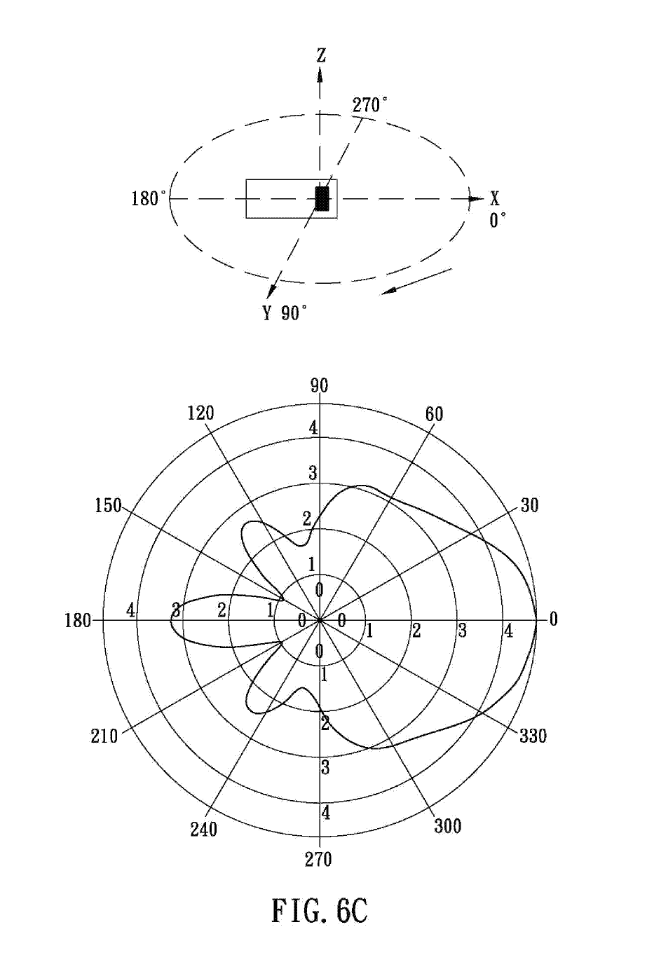

To clearly disclose the RFID capabilities of the packaging material 1 of the present invention, referring to FIGS. 1, 2, and 6A˜6C, a far-field distance test was conducted by the inventor using the Tagformance Lite system developed by Voyantic of the Netherlands, with the test frequency band being the UHF band (922˜925 GHz) and the test distance being 31 cm. The results are plotted in FIGS. 6A˜6C, in which FIG. 6A shows the XZ-cut (horizontal) scanning direction and radiation pattern, FIG. 6B shows the YZ-cut (vertical) scanning direction and radiation pattern, and FIG. 6C shows the XY-cut (horizontal) scanning direction and radiation pattern. According to the radiation patterns, the RFID tag 17A did operate well, and the best reading performance took place above the packaging material 1 (i.e., in a vertical direction). Therefore, the packaging material 1 of the present invention (see FIG. 1) indeed has good RFID capabilities and is suitable for making the desired products (e.g., the package bag 1A).

The terms used in the present specification are explanatory only and should not be viewed as limitations of the present invention. Moreover, application of the present invention is not limited to the structure described and shown herein. As the foregoing embodiment is but one preferred embodiment of the present invention, implementation of the present invention is by no means limited thereto. A person skilled in the art who has fully understood the concept of the present invention may modify the detailed features of the packaging material of the present invention by changing the thickness and material of the surface material or the bottom material or by providing an additional ink layer or additional adhesive. As long as a T-shaped slot is formed in the metal layer of a packaging material during production of the packaging material, and a T-shaped slot antenna is designed accordingly to impart RFID capabilities to the packaging material, the resultant product should fall within the scope of the present invention. In a nutshell, the packaging material of the present invention is made by forming a T-shaped slot in the metal layer of a conventional packaging material and installing a communication device thereon. The present invention not only allows a packaging material with RFID capabilities to be rapidly made in a single process, but also can reduce the overall production costs of the packaging material significantly.

While the invention herein disclosed has been described by means of specific embodiments, numerous modifications and variations could be made thereto by those skilled in the art without departing from the scope of the invention set forth in the claims,

What is claimed is:

1. A packaging material with a T-shaped slot antenna, the packaging material comprising:
a surface material which is a film made of a plastic material and is formed with a first T-shaped slot;
a metal layer coated on a surface of the surface material and formed with a second T-shaped slot, the second T-shaped slot comprising a vertical groove and a horizontal groove, the vertical groove having a first end connected to a central position of the horizontal groove and a second end extending toward a lateral edge of the metal layer such that the metal layer forms a T-shaped slot antenna, the second T-shaped slot having a same configuration as the first T-shaped slot and corresponding to the first T-shaped slot;
a bottom material which is a film made of a plastic material, has a surface coated on the metal layer, and is formed with a third T-shaped slot, the third T-shaped slot having the same configuration as the second T-shaped slot and corresponding to the second T-shaped slot; and
a communication device comprising a connecting material, two conductive sheets, and a communication chip, the connecting material being a film made of a plastic material, the conductive sheets being attached to the connecting material, the conductive sheets having corresponding inner lateral edges which are spaced from each other and are respectively connected to feed-in ends of the communication chip, the connecting material being attached to the surface material or the bottom material by an adhesive, the communication chip being positioned at a position corresponding to the vertical groove, the conductive sheets having peripheries which do not cover the horizontal groove completely, such that the communication chip can transmit or receive information via the T-shaped slot antenna.

2. The packaging material of claim 1, wherein the second end of the vertical groove is spaced from the lateral edge of the metal layer by a matching spacing.

3. The packaging material of claim 2, further comprising a second connecting material, the second connecting material being a film made of a plastic material, the second connecting material having a surface coated on the conductive sheets and the communication chip such that the conductive sheets and the communication chip are located between the second connecting material and the connecting material.

4. The packaging material of claim 3, wherein the corresponding inner lateral edges of the conductive sheets are serrated.

5. The packaging material of claim 2, wherein the matching spacing has a length ranging from 13% to 20% of a length between corresponding outer lateral edges of the conductive sheets that face away from each other.

6. The packaging material of claim 3, wherein the matching spacing has a length ranging from 13% to 20% of a length between corresponding outer lateral edges of the conductive sheets that face away from each other.

7. The packaging material of claim 4, wherein the matching spacing has a length ranging from 13% to 20% of a length between corresponding outer lateral edges of the conductive sheets that face away from each other.

8. The packaging material of claim 5, wherein the vertical groove has a width ranging from 16% to 24% of the length between the corresponding outer lateral edges of the conductive sheets that face away from each other.

9. The packaging material of claim 6, wherein the vertical groove has a width ranging from 16% to 24% of the length between the corresponding outer lateral edges of the conductive sheets that face away from each other.

10. The packaging material of claim 7, wherein the vertical groove has a width ranging from 16% to 24% of the length between the corresponding outer lateral edges of the conductive sheets that face away from each other.

11. The packaging material of claim 8, wherein the horizontal groove has a width ranging from 10% to 17% of the length between the corresponding outer lateral edges of the conductive sheets that face away from each other.

12. The packaging material of claim 9, wherein the horizontal groove has a width ranging from 10% to 17% of the length between the corresponding outer lateral edges of the conductive sheets that face away from each other.

13. The packaging material of claim 10, wherein the horizontal groove has a width ranging from 10% to 17% of the length between the corresponding outer lateral edges of the conductive sheets that face away from each other.

14. The packaging material of claim 11, wherein the communication chip corresponds in position to a central axis of the vertical groove.

15. The packaging material of claim 12, wherein the communication chip corresponds in position to a central axis of the vertical groove.

16. The packaging material of claim 13, wherein the communication chip corresponds in position to a central axis of the vertical groove.

17. The packaging material of claim 14, wherein the conductive sheets have edges respectively flush with edges of the horizontal groove.

18. The packaging material of claim 15, wherein the conductive sheets have edges respectively flush with edges of the horizontal groove.

19. The packaging material of claim 16, wherein the conductive sheets have edges respectively flush with edges of the horizontal groove.

20. The packaging material of claim 17, wherein the bottom material comprises a composite material composed of two films which are respectively defined as a first base layer and a second base layer.

21. The packaging material of claim 18, wherein the bottom material comprises a composite material composed of two films which are respectively defined as a first base layer and a second base layer.

22. The packaging material of claim 19, wherein the bottom material comprises a composite material composed of two films which are respectively defined as a first base layer and a second base layer.
